(19) United States
(12) Patent Application Publication
(10) Pub. No.: US 2015/0260531 A1
(43) Pub. Date: Sep. 17, 2015

(54) ROUTE PLANNING SYSTEM AND METHODOLOGY WHICH ACCOUNT FOR SAFETY FACTORS

(71) Applicants: Pouya Johnathon Ehsani, Washington, DC (US); Christopher Bayan Bruss, Washington, DC (US); Jian Khadem Khodadad, Washington, DC (US)

(72) Inventors: Pouya Johnathon Ehsani, Washington, DC (US); Christopher Bayan Bruss, Washington, DC (US); Jian Khadem Khodadad, Washington, DC (US)

(73) Assignee: LOGAWI DATA ANALYTICS, LLC, Washington, DC (US)

(21) Appl. No.: 14/205,495

(22) Filed: Mar. 12, 2014

(51) Int. Cl. G01C 21/34; G01C 21/36

(52) U.S. Cl. CPC G01C 21/34; G01C 21/36

(57) ABSTRACT

A system and methodology that provides travel routes that minimize crash risk and add a safety factor to the determination of preferred routes of travel. Multiple elements of safety are considered in determining preferred routes of travel. This may include consideration of the user's physiological and/or psychological state during the time of travel. Alternatively or in addition, required driving maneuvers, roadway crash histories, demographic data and/or secondary task engagement while driving by the user may be considered in determining the optimal route of travel given the foregoing safety factors.

### FIELD OF THE INVENTION

The present invention relates generally to route planning in various transportation modes and more specifically to the determination of preferred routes based on safety factors and personal characteristics.

### BACKGROUND OF THE INVENTION

Motor vehicle crashes are a leading cause of fatal and disabling injuries worldwide. Epidemiological evidence suggests motor vehicle crashes are predictable and preventable, and not “accidents” or due to “bad luck”. Multiple factors are involved in measuring crash risk, including vehicle design, roadway engineering, weather conditions, and driver behavior.

In recent years, navigation systems have become commonplace in vehicles, either through in-built systems provided by the vehicle manufacturer, or as after-market nomadic electronic devices. Existing navigation systems provide route options for drivers that are optimized to reduce travel time or the cost of the trip (e.g. by avoiding tolls). These systems use a range of data sources to provide route suggestions including feedback from vehicles on the road, data uploaded by drivers and third party sources.

Existing navigation systems do not currently take into account data specific to the individual driver (either or both of historical or current state data) in making routing determinations. Routing based at least in part on this information would allow drivers and systems to make a choice of driving route according criteria that goes beyond time or cost. It is clear therefore, that current approaches to providing route suggestions for drivers are not ideal, and by taking into account factors which are likely to minimize the risk of accidents along the planned route, an improved functionality can be provided.

### SUMMARY OF THE INVENTION

It is a primary object of the present invention to overcome the limitations of the prior art.

It is another object of the present invention to provide a comprehensive system and methodology that provides individuals with the safest possible route to a destination given a choice of multiple, alternative routing options.

It is a further object of the present invention to determine routing having the lowest crash risk, given what is known about roadway, required driving maneuvers, individual crash risk, and other factors.

It is a still further object of the present invention to providing routing options in the context of various modes of transportation to include, without limitation, automobiles, pedestrians, fleets of vehicles including trucks and buses, boats, bicycles and various forms of public transportation.

It is another object of the present invention to employ one or more of, environmental factors (such as weather, road characteristics, etc.), demographic factors (such as expected behavioural patterns associated with driving for particular demographic groups including personality types), and individual factors (current and historical individual driver psychological, and physiological characteristics), in connection with route planning and the selection of the route which is expected to be the safest based on some or all of the foregoing factors.

It is still another object of the present invention to provide a system and methodology which assesses the crash risk of each possible route to a desired destination based on the historical safety data associated with each set of roadways forming a potential route.

It is a further object of the present invention to provide an overall crash risk assessment for each possible route to a destination.

It is a further object of the present invention to provide a system and methodology which assesses the crash risk of an individual driver, based on demographic characteristics, and to provide route suggestions that minimize high risk driving maneuvers for the driver, based on what is known about motor vehicle crash epidemiology.

It is a still further object of the present invention to provide a system and methodology to provide route suggestions based on the psychological and physiological conditions of the driver.

It is a yet a further object of the present invention to provide a system and methodology that provides a safety assessment for a range of possible driving routes bases on historical patterns of crashes on the roadways, combined with individual level crash risk factors that account for the drivers' dynamic risk profile, and suggesting the safest possible route.

It is another object of the present invention to provide a system and methodology that provides the option for modifying route selection during travel along a route based upon a change to available data used in selection a preferred route.

It is still another object of the present invention to provide a system and methodology that automatically modifies route selection to a newly preferred route during travel along a route based upon a change to available data used in selection a preferred route.

It is yet another object of the present invention to provide a system and methodology that accounts for various historical behavioural characteristics of a driver in connection with route selection.

It is a still further object of the present invention to provide a system and methodology that accounts for various real time behavioural characteristics of a driver, either just before traveling a route and/or during the time of travel of the route, in connection with potential changes to preferred routing during route travel.

It is an even further object of the present invention to provide a system and methodology that accounts for various real time behavioural characteristics of a driver, such as the sending of text messages, talking on a phone, sending emails, etc., either just before traveling a route and/or during the time of travel of the route, in connection with potential changes to preferred routing during route travel.

It is yet another object of the present invention to provide an individual user with route suggestions, based on the demographic, psychological, and physiological characteristics of all other users of the system. When the system has the profiles of a critical numbers of users on the road at any given time, it may provide routing suggestions based on both (1) the individual user's psychological, and physiological state and (2) the psychological, and physiological state of other drivers that either take a route or on the road at a given period of time.

It is an even further object of the present invention to provide users with warnings of dangerous driving conditions, related to either the profiles of other drivers on the road, or roadway conditions.

It is a still further object of the present invention to alert third parties if an individual's critical thresholds for safety indicators are exceeded. For example, if an individual is assessed as unfit to drive based on various sources of data; third parties could be alerted (e.g. designated kin) when physiological and/or psychological thresholds are exceeded.

It is an even further object of the present invention to allow fleet managers to identify suitable drivers for particular routes, based on the psychological, and physiological information of individual drivers available to them. In this way, a fleet manager may be able to ensure that the highest risk drivers are on the lowest risk routes.

These and other objects of the present invention are achieved through the disclosed system and methodology that provides travel routes that minimize crash risk and address the shortcomings of the prior art as discussed above. Multiple elements of safety are considered in determining preferred routes of travel. An exemplary element is estimating the crash risk of the possible roadway(s) along a route. This may be quantified by dividing the number of previous crashes on the roadway(s) by the typical traffic volume for the roadway(s). Route suggestions are provided that have the lowest overall crash risk across the entire driving route to reach the destination.

Another exemplary safety element that may be considered by the present invention in connection with route determination is the crash risk associated with required driving maneuvers to reach the destination. Navigation instructions may be provided such that high-risk driving maneuvers are minimized or eliminated. Another exemplary element that may be considered in route selection is individual risk assessment, based on the psychological and physiological conditions of the user. Using a range of data sources, an individual's risk is assessed and route suggestions are provided that account for the individual's dynamic risk profile. By aggregating data from the above elements as well as others, route suggestions are provided that maximize safety.

### BRIEF DESCRIPTION OF THE DRAWINGS

FIG. 1 is a diagram illustrating the system of the present invention and the major components thereof, according to a preferred embodiment thereof;

FIG. 2 is a depiction of the system functionality associated with roadway crash risk assessment according to a preferred embodiment of the present invention;

FIG. 3 is a depiction of the system functionality associated with driving maneuver analysis according to a preferred embodiment of the present invention; and

FIG. 4 is a depiction of the system functionality associated with driver psychological and physiological characteristic analysis according to a preferred embodiment of the present invention.

### DETAILED DESCRIPTION

A description of the present invention in preferred embodiments thereof, now follows. In connection with the following discussion, it will be understood by one of skill in the art that while the description generally references implementation within a vehicle, the scope of the present invention is not specifically limited thereto in that the discussion may, in most cases, be readily applied to implementations for use in connection with other forms of transportation such a pedestrians, boats, fleets, bicycles, and various forms of public transportation.

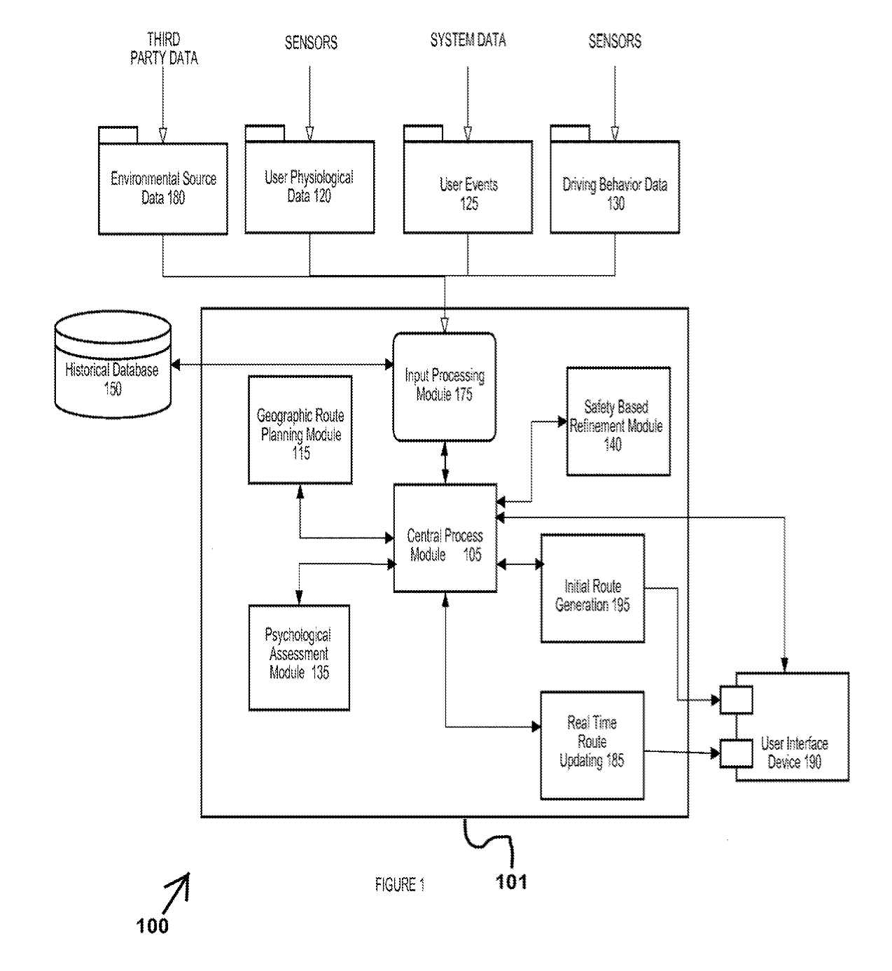

With reference now to FIG. 1, the system of the present invention, in a preferred embodiment thereof, is now described. FIG. 1 illustrates the Safety Based Navigation System (SBNS) 100 and various components associated therewith in a preferred embodiment of the present invention. SBNS 100 includes a number of modules that work collaboratively with the primary function of receiving data from various sources and generating proposed navigational routes including applicable safety data associated with each. In some embodiments, SBNS 100 automatically chooses the preferred route which is typically the safest route for the user and in other embodiments, SBNS 100 may offer the user various options from which the user may select his or her desired route. Routes may be generated initially prior to the beginning of travel and may be updated during travel along the selected route based on new or different data being made available to SBNS 100 over time.

Preferably, all modules within SBNS 100 are under the direction and control of central process module 105. In a preferred embodiment, there are a number of source inputs to SBNS 100 from which it may determine available routes along with the safety data associated with each. In addition, and although not shown in FIG. 1, SBNS 100 may receive from external sources, general navigational data such as streets, highways, points of interest etc. as is known in the art and as is available from a number of third party providers. This data may be provided and updated in various manners included via CD or DVD-ROM or wirelessly etc.

As shown in FIG. 1, various external input sources are available and are now described. Environmental source data 180 may include information associated with various routes and roadways as well as other environmental conditions and situations. Examples include weather, roadway construction data, traffic data, planned events or concerns in the areas of the proposed travel routes, etc. This data may vary by time of day/day of week and is thus preferably available to SBNS 100 in that context so that routes may be rated for safety based on planned time of actual travel.

User physiological data 120 preferably comprises data representing the physiological state of the user. The user in this context typically refers to the driver of the vehicle or in the case of traveling by foot, the pedestrian. In a preferred embodiment, various sensors are available in-vehicle or on-person to capture the required parameters as may be known in the art. Examples of data falling into this category includes body related data such as blood pressure, respiratory rate, heart rate, body temperature, blood sugar level, oxygen saturation, pupil dilation, muscle tone, hormone levels, presence of impairing drugs within the body, etc. Some or all of this data can be measured by sensors inside and outside the body. As will be discussed below, this data can either be used for decision making in raw form or the data can be processed to make determinations (e.g. user stress level, etc.) which are then in turn used for decision making.

User events 125 preferably comprises data which may either be entered by a user/driver, entered by another person or obtained from a third party source. This type of data includes information indicative of events associated with the user's life which might be viewed to have an impact on the user's predicted behavior which could affect safety. Again, as noted, the “user” in this context could be a driver of a vehicle, someone prepared to walk a route, etc. The user events data may be helpful to SBNS 100 in making determinations as to which is the optimal route for the user given this available data and safety considerations. Examples of this class of data may include data which could be entered manually such as hours of sleep from the night before, number and/or ages of passengers in the vehicle, etc. Alternatively or in addition, user events data 125 may include data which is automatically captured. Examples of this may include type of music being played in the vehicle, recent/historical driving behavior of friends/colleagues, in-vehicle secondary task engagement behaviors such as number of text messages sent, content of messages sent, amount of web-browsing and/or categories of websites being visited, number of emails sent, content of emails being sent, number and length of phone calls being made will operating the vehicle, etc. User events data 125 can also encompass the anonymized event data and of all other users in the system. The user events data may be helpful to SBNS 100 in making determinations as to which is the optimal route for the user given this available data and safety considerations.

Yet another source of data which is preferably available to SBNS 100 is driving behavior data 130. This represents data associated with the user's driving behavior both in real time as the selected travel route is traversed and/or historical driving behavior associated with the user. For example, this data may include vehicle operating data as operated by the user such as longitudinal deceleration/hard braking, longitudinal acceleration/rapid starts, hard left and hard right turns, excessive speed either in general or given data about the specific roadway the vehicle is on at the time speed is measured, yaw (the delta between an initial turn and a correction), overall speed profile on a trip, overall acceleration and deceleration profiles on a current trip, etc. Some or all of this data can be measured by sensors within the vehicle such as via accelerometers, GPS data, etc.

Driving behavior data 130 may also comprise historical data associated with the user's driving behavior such as driving records available at the Department of Motor Vehicles, police and court records, insurance data etc. This data may show, for example, previous citations for speeding, previous crashes, etc.

In addition to the foregoing, historical data may be stored and retrieved from historical database 150. This database may be used to track data originating from any or all of the previously described data sources as such data is captured over time for a particular user as that user drives or walks various routes. This data may then be used as a benchmark against current or very recent data associated with a user to determine deviations from normal behavior. For example, historical database 150 may store data for one or more users regarding items such as average number of texts sent per time period while driving, average time spent on phone calls while driving, average number of emails sent while driving, average hours of sleep obtained by a user per night and other data. Current or recent data associated with a user may then be used by SBNS 100 to select the optimal route among various available routing options, to advise a driver not to drive at all or make other determinations. Similarly, as user data changes during traversal of a selecting route, SBNS 100 may compare this data as against data in historical database 150 to update routes and/or routing preferences.

Now that the various input datasets which are preferably available to SBNS 100 in a preferred embodiment have been described, the various components associated with processing of that data and interfacing with a user in connection with providing optimal safety based routing are now discussed. In connection with this aspect, user interface device 190 communicates with SBNS 100 to permit a user to make input to the system as well as to display available routing to the user. In some embodiments, user interface may comprise a special purpose device such as a navigation system included, in, for example, an automobile. Alternatively, user interface device 190 may be a laptop, tablet, smartphone or other mobile device that allows for display and input by a user.

Turning now to the specific processing components of SBNS 100, of note is that control of SBNS 100 is managed by central process module 105. Various actions may be initiated by SBNS 100 itself and/or by a user via interaction with user interface device 190. These actions and commands are either generated internally within SBNS 100 based on an event or based on some scheduled activity or they are initiated via a command transmitted by user interface device 190 to central process module 105. Examples of these commands may include, without limitation, instantiation of a routing creation process, selection of one or more routes by a user, updating routing information based on newly available data, selection of various settings by a user reflecting desired behavior of SBNS 100, as well as other commands and activities.

Initial processing module 175 processes all input received from external data sources as described above and formats and converts data as necessary. This module further makes such data available to other modules within SBNS 100 as needed under the control of central process module 105. Geographic route planning module 115 is responsible for route planning as is known in the art. This module employs available geographic and road data to generate one or more possible routes from origin to destination under the control of central process module 105. Geographic route planning module preferably has access to road and geographic data which may be updated from time to time either wirelessly or through available update CD-ROM, DVD-ROM or other storage media.

Psychological assessment module 135 uses applicable and available source data in order to classify a user into one or more emotional and personality classifications. These classifications to which the user is assigned may be historical/averaged/typical classifications for the user over time, in which case they are preferably stored in historical database 150 as a benchmark or, alternatively or in addition, personality assessment module may use real or near real time data to assign the user to one or more personality groupings based as or just before a route is traveled. A wide variety of personality classifications may be assigned to a user based on available data. For example, a user may be classified by emotional state such as, for example, “angry”, “neutral”, “depressed”, “sad”, “unstable”, etc. depending upon various input data including that which has been described above such as communication patterns (e.g. content of emails), blood pressure, heart rate, etc. Data may be used to classify based upon preset ranges and/or based on deviation from benchmark data for a particular user. Similarly, another classification may be based on personality characteristics such as the Myers Briggs or the “big five” personality traits: openness, conscientiousness, extraversion, agreeableness, neuroticism and other factors such as sensation seeking. These data can be generated from user provided date, wearable devices, electronic applications, text analytics, and other sources. Along these lines, users may be classified according to demographic data which may be captured to make determinations about preferred routing either alone or in combination with other user specific and environmental data as further described herein.

Safety based refinement module 140, under the control of central process module 105, receives one or more available routes generated by geographic route planning module 115 and either selects the one or more optimum routing options automatically for the user or determines which available routes should be presented to the user for selection of a route by user. In the latter case and in a preferred embodiment, safety based refinement module provides the user with safety risk factor information associated with each potential route so that user can make an informed decision about which route to select for actual travel. As discussed above, one key aspect of the present invention is that the system and methodology account for safety based factors in making routing determinations. These factors may be based on any or all of the following:

1) Known real time environmental factors such as weather and/or traffic associated with one or more available routes;

2) User personality characteristics either in and of themselves at the present time or based on comparison to a historical benchmark;

3) Known historical data associated with the user such as driving record;

4) Current, recent and/or historical user task data such as emails sent, texts sent, calls made during driving/walking activity as well as content information available which may be associated with emails, texts, calls etc. This information may be used either alone or as against a historical benchmark;

5) User physiological data either alone or as against historical benchmarking data;

6) Demographic and personality classifications such as by gender, age, ethnic grouping etc. For example, the system may be configured such that based on known and available data, decisions such as preferred routes for females may differ from preferred routes for males all other factors being equal. By way of example only, routes generated for females may prefer only right hand turns while those for males may have no preference or a preference for left hand turns. Again, these preferences are based on historical data which is available and tied to safety data associated with various groupings. Each of the above items as well as others described herein are used by safety based refinement module 140 to prioritize and/or select routes among a plurality of available routes so as to minimize safety risks. These risks may be external to the user, user specific, or both.

Initial route generation module 195 generates a preferred and safety optimized route from all available routes to include processing accomplished by safety based refinement module 140 just described above. This route may be automatically selected for the user or the user may be presented with some or all of the available routes for selection by the user preferably with available safety risk information informing the user's decision. The route ultimately generated and selected via initial route generation module 195 is the initial route prior to beginning travel.

In contrast, real time route updating module 185 is responsible for updating preferred routing in real time as a route is traversed based on additional data which may become available. This data may include, for example, changes in the user/driver's vital signs such as heart rate, blood pressure etc. (e.g. a user becoming more stressed may be rerouted to a safer route even though it may be longer), or changes in environmental conditions such as traffic and/or weather (e.g. separate and apart from any changes associated with user vital signs, a user may be rerouted just based on changes in traffic conditions). Real time routing updating module 185 can also encompass the anonymized data and of all other users in the system. This real time data may be helpful to SBNS 100 in making determinations as to which is the optimal route for the user given available data and safety considerations.

Now that SBNS 100 and its various components have been described, the following discussion provides some additional details regarding the various processes and exemplary embodiments associated with selecting preferred routing options based on one or more safety factors.

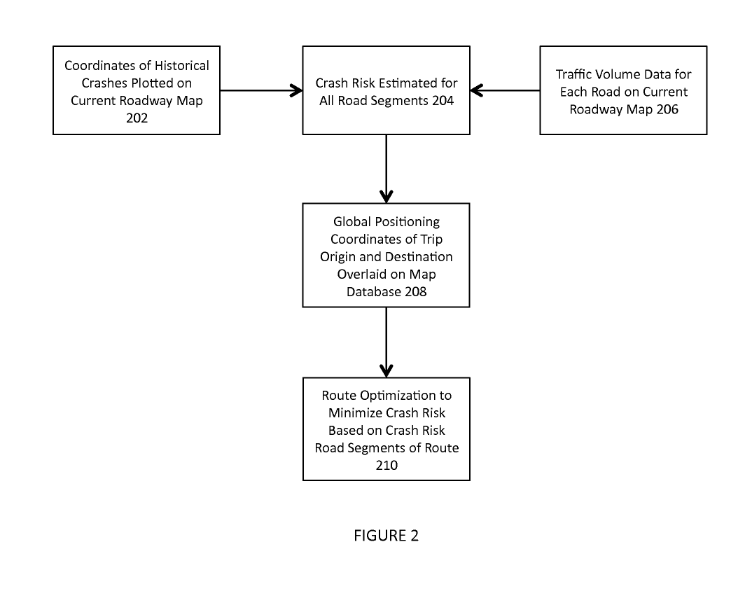

Referring now to FIG. 2, it is noted that safety based refinement module 140 may include a roadway crash risk assessment functionality. This functionality may employ existing crash databases which include the longitude and latitude coordinates of previous crashes, and possibly the driving conditions at the time of crash. Periodic surveys estimate the traffic volume on each roadway. Using the number of crashes on a particular roadway, traffic volume and driving conditions (such as time of day, and weather), the relative crash risk for the particular roadway can be quantified.

In particular, and again with reference to FIG. 2, historical crash data may be associated with roadway data and plotted on a roadway map (202). This data may be sourced in real time including via environmental source data 180 or stored in historical database 150 for access when needed. In addition to this information, traffic volume data for the same roadway or roadway segment may be obtained (206), again, either in real time or as stored in historical database 150. These two datasets may be combined to determine a crash risk value for a road segment which takes into account crashes relative to volume (204). Once this is determined, this data may be used in connection with all available routes made available via geographic route planning module 115 to determine the optimal routing and/or rank routing options based on crash risk (208 and 210).

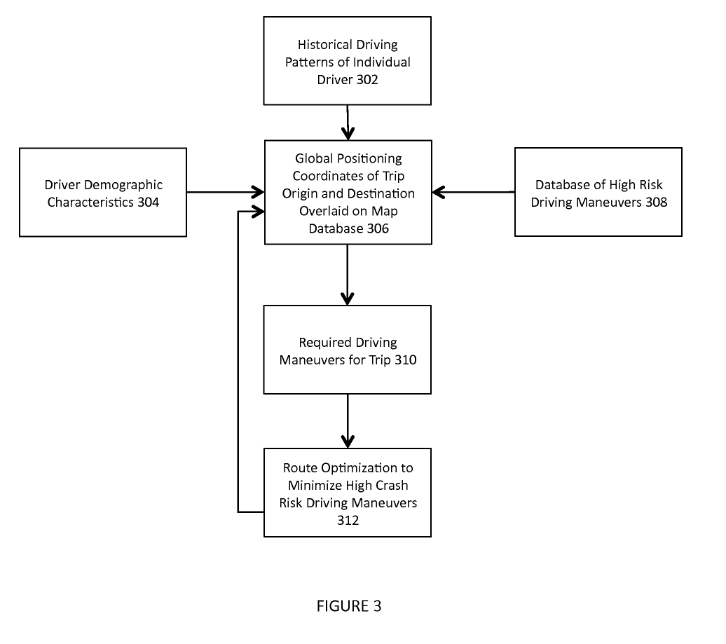

As mentioned above and with reference to FIG. 3, SBNS 100 may also consider demographic classifications for users and expected behavior based thereupon in making determinations about preferred routing based on safety factors. For example, certain driving maneuvers entail greater crash risk than others. Data related to driving in the United States of America illustrates a left turn that crosses a lane of opposite flowing traffic entails a high crash risk. Drivers of a certain age and sex have a greater likelihood of crash while conducting some driving maneuvers. For example, females are more likely to crash while turning left relative to males. Using the demographic characteristics of each individual driver, the crash risk profiling may be employed to provide route suggestions that minimize high-risk driving maneuvers based on the demographic characteristics of the individual driver. This information is paired with historical driving behavior of the individual driver to provide an individual measure of driving maneuver crash risk.

In particular, historical driving patters of the user may be retrieved from historical database 150 (302) and combined with driver demographic characteristics (304) and access to a database of high risk driving maneuvers (308) to overlay the various available routing options generated by geographic route planning module 115 (306). This, in turn, is used to generate the required driving maneuvers for each routing option associated with a planned trip (310). Based on the available data as discussed, routing options can be determined and or ranked based on likelihood of a crash given required driving maneuvers for each available route (312).

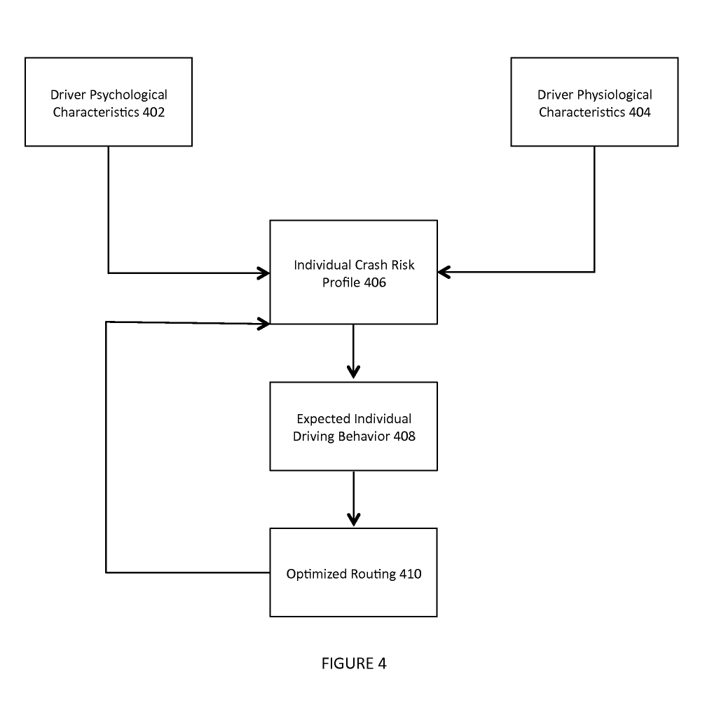

According to one embodiment of the present invention, and with reference to FIG. 4, safety based refinement module 140 may include an individual crash risk profiling component that uses psychological and physiological characteristics of the individual to provide the safest driving route suggestions. Personality characteristics are known to be associated with crash risk. For example, a personality trait, such as conscientiousness is inversely associated with aggressive driving and speeding. Drivers' personality characteristics can be provided through survey based assessments or other data sources. Emotional conditions such as anger are known to increase crash risk. Emotions may be affected by situational conditions, such as the presence of passengers in the vehicle, underlying pathology (e.g. depression) or other factors. Using a range of data sources, emotional conditions are assessed to generate a dynamic risk profile for each individual driver. Physiological conditions such as stress levels are associated with a greater risky driving behavior. Using a variety data sources, drivers' physiological conditions are incorporated into the route suggestions provided by the navigation system.

Driving behavior may be paired with psychological, emotional and physiological data, providing dynamic feedback for the individual crash risk profiling system. SBNS 100 then calibrates the suggested driving route to accommodate for the psychological, emotional and physiological state of the driver.

In particular, any or all of driver psychological (402), and/or physiological (404) characteristics may be aggregated to form an individual crash risk profile for a user (406). Based on this profile, an expected driving behavior for an individual driver can be obtained (408). This data may then be applied against all available routes generated by geographic route planning module 115 in order to optimize routing based on safety considerations.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

1. A navigation system for providing travel routes that maximize the likelihood of safe travel by a driver of a vehicle, the system comprising:
at least one parameter-sensing system including at least one of:
an in-vehicle-sensory-distraction (IVSD) parameter-sensing system;
an in-vehicle secondary-task-engagement (IVSTE) parameter-sensing system; and
a driver-emotion-suggestive vehicular (DESV) parameter-sensing system;
a driver-interface; and
one or more processors configured to execute computer program modules, the computer program modules comprising:
a geographic route planning module configured to generate at least one possible routes of travel from a starting location to a destination location;
a safety based refinement module configured to assess each of said at least one possible routes for at least one safety factor, associated with each of said at least one possible routes of travel, based on information from the at least one parameter-sensing system; and
an initial route generation module configured to interact with the driver via the driver-interface and thereby present said at least one possible routes and the at least one corresponding assessed safety factors, respectively, and receive a selection therefrom as an initial route to be traversed.

2. (canceled)

3. (canceled)

4. The navigation system of claim 1 wherein said at least one wherein:
the computer program modules further include:
a psychological assessment module configured to classify the driver into one or more classifications according to at least one psychological trait associated therewith; and
the safety based refinement module is further configured to assess based on the one or more classifications.

5. The navigation system of claim 1 wherein:
the computer program modules further include:
a psychological assessment module configured to classify the driver into one or more classifications according to at least one demographic group to which the driver belongs; and
the safety based refinement module is further configured to assess based on the one or more classifications.

6. (canceled)

7. The navigation system of claim 1 further comprising an input processing module for receiving external data used by said safety based refinement module in determining said selected route of travel.

8. The navigation system of claim 7 wherein said external data comprises roadway segment historical crash data.

9. The navigation system of claim 8 wherein said roadway segment historical crash data comprises data reflecting the number of crash incidents relative to historical traffic flow on said roadway segment.

10. (canceled)

11. The navigation system of claim 1 further comprising a real time route updating module, wherein said real time route updating module reassesses the selected route of travel based on updated data received by said navigation system during traversal of said selected route of travel by said vehicle.

12. The navigation system of claim 1 wherein at least one third party is notified if said selected route of travel is determined to be outside of a predetermined risk profile associated with said individual operating a vehicle.

13. The navigation system of claim 1 wherein fleet managers can identify suitable drivers for particular routes based on said at least one safety factor.

14. (canceled)

15. The navigation system of claim 1 wherein said safety based refinement module determines said selected route of travel based upon the characteristics of all users in the system.

16. A method for providing travel routes that maximize the likelihood of safe travel comprising:
sensing parameters including at least one of:
an in-vehicle-sensory-distraction (IVSD) parameter;
an in-vehicle secondary-task-engagement (IVSTE) parameter; and
a driver-emotion-suggestive vehicular (DESV) parameter;
generating at least one possible route of travel from a starting location to a destination location;
assessing each of said at least one possible routes for at least one safety factor, associated with each of said at least one possible routes of travel, based on the sensed parameters; and
interacting, via a driver-interface, with the driver including:
presenting said at least one possible routes and the at least one corresponding assessed safety factors, respectively; and
receiving a selection from amongst said at least one possible routes therefrom as an initial route to be traversed.

17. (canceled)

18. (canceled)

19. The method of claim 16 wherein:
the method further comprises:
classifying the driver into one or more classifications according to at least one psychological trait associated with therewith; and
the assessing includes:
assessing based on the one or more classifications.

20. The method of claim 16 wherein:
classifying the driver into one or more classifications according to at least at least one demographic group to which the driver belongs; and
the assessing includes:
assessing based on the one or more classifications.

21. (canceled)

22. (canceled)

23. The method of claim 16 wherein:
the method further comprises:
receiving external data including roadway segment historical crash data; and
the assessing each of said at least one possible routes is based at least in part on said external data.

24. The method of claim 23 wherein said roadway segment historical crash data comprises data reflecting the number of crash incidents relative to historical traffic flow on said roadway segment.

25. (canceled)

26. The method of claim 16 further comprising reassessing the selected route of travel based on updated data received during traversal of said selected route of travel by said vehicle.

27. The method of claim 16 wherein at least one third party is notified if said selected route of travel is determined to be outside of a predetermined risk profile associated with said individual operating a vehicle.

28. The method of claim 16 wherein said safety based refinement module determines said selected route of travel based upon the characteristics of a plurality of users in the system.

29. The navigation system of claim 1, wherein the in-vehicle-sensory-distraction (IVSD) sensing system is configured to sense at least one of the following:
a type of sonic-stimulation being generated by a sound-generation system of the vehicle.

30. The navigation system of claim 1, wherein the in-vehicle secondary-task-engagement (IVSTE) sensing system is configured to sense at least one of the following:
a number of text messages sent by the driver while operating the vehicle;
content of messages sent by the driver while operating the vehicle;
an amount of web-browsing conducted by the driver while operating the vehicle;
categories of websites visited by the driver while operating the vehicle;
a number of emails sent by the driver while operating the vehicle;
content of emails sent by the driver while operating the vehicle;
a number of phone calls made by the driver while operating the vehicle; and
lengths of phone calls made by the driver while operating the vehicle.

31. The navigation system of claim 1, wherein the driver-emotion-suggestive vehicular (DESV) sensing system is configured to sense at least one of the following:
vehicular braking deceleration while the selected route is being traversed;
throttle-induced, longitudinal vehicular acceleration while the selected route is being traversed;
steering-input induced angular acceleration while the selected route is being traversed;
speed relative to posted speed-limits while the selected route is being traversed; and
vehicular yaw while the selected route is being traversed.

32. The navigation system of claim 1, wherein the at least one sensing system further includes:
a driver-physiology (DP) parameter-sensing system.

33. The navigation system of claim 32, wherein the driver-physiology (DP) parameter-sensing system is configured to sense, with respect to the driver, at least one of the following:
blood pressure;
respiratory rate;
heart rate;
body temperature;
blood sugar level; blood oxygen saturation;
pupil dilation;
muscle tone;
hormone levels; and
body-chemistry indicative of a presence of an impairing drug.

34. The method of claim 16, wherein sensing an in-vehicle-sensory-distraction (IVSD) parameter includes:
sensing a type of sonic-stimulation being generated by a sound-generation system of the vehicle.

35. The method of claim 16, wherein sensing an in-vehicle secondary-task-engagement (IVSTE) parameter includes at least one of the following:
sensing a number of text messages sent by the driver while operating the vehicle;
sensing content of messages sent by the driver while operating the vehicle;
sensing an amount of web-browsing conducted by the driver while operating the vehicle;
sensing categories of websites visited by the driver while operating the vehicle;
sensing a number of emails sent by the driver while operating the vehicle;
sensing content of emails sent by the driver while operating the vehicle;
sensing a number of phone calls made by the driver while operating the vehicle; and
sensing lengths of phone calls made by the driver while operating the vehicle.

36. The method of claim 16, wherein sensing a driver-emotion-suggestive vehicular (DESV) parameter includes at least one of the following:
sensing vehicular braking deceleration while the selected route is being traversed;
sensing throttle-induced, longitudinal vehicular acceleration while the selected route is being traversed;
sensing steering-input induced angular acceleration while the selected route is being traversed;
sensing speed relative to posted speed-limits while the selected route is being traversed; and
sensing vehicular yaw while the selected route is being traversed.

37. The method of claim 16, wherein the sensing parameters further includes:
sensing a driver-physiology (DP) parameter.

38. The method of claim 37, wherein the sensing a driver-physiology (DP) parameter includes at least one of the following:
sensing blood pressure;
sensing respiratory rate;
sensing heart rate;
sensing body temperature;
sensing blood sugar level; blood oxygen saturation;
sensing pupil dilation;
sensing muscle tone;
sensing hormone levels; and
sensing body-chemistry indicative of a presence of an impairing drug.
